(19) United States
(12) Patent Application Publication
(10) Pub. No.: US 2016/0171416 A1
(43) Pub. Date: Jun. 16, 2016

(54) REAL ESTATE AGENT RATING

(71) Applicant: ZipRealty LLC, Emeryville, CA (US)

(72) Inventors: James Wilson, Emeryville, CA (US); Colin McConnell, Emeryville, CA (US)

(21) Appl. No.: 14/565,694

(22) Filed: Dec. 10, 2014

(51) Int. Cl. G06Q 10/06; G06Q 50/16; G06Q 30/02

(52) U.S. Cl. CPC G06Q 10/06398; G06Q 10/06393; G06Q 30/0282; G06Q 50/16

(57) ABSTRACT

A system comprising a computer-readable storage medium storing at least one program and a computer-implemented method for rating real estate agents are presented. Consistent with some embodiments, the method may include accessing agent activity data representing actions performed by a real estate agent while using a network-based real estate service. The method further includes calculating an engagement score and a prospecting score for the real estate agent using portions of the agent activity data. In some embodiments, the method may further include calculating a transactional score for the real estate agent based on the agent's historical transaction data. The method may then determine a composite agent rating for the agent using the engagement score, prospecting score, and in some embodiments, the transactional score. The agent composite rating may then be presented to users of the network-based real estate service.

### TECHNICAL FIELD

This application relates generally to data processing within a network-based system and, more specifically, to features of a real estate agent rating system.

### BACKGROUND

Currently, a vast amount of real estate transactions are performed online. For example, real estate agents may take advantage of network-based real estate services to perform tasks such as drafting and transmitting offers for purchases of properties. Consumers, on the other hand, may be able to utilize other network-based real estate services to search through online property listings or schedule tours with real estate agents. Current technologies are, however, limited in functionality and are deficient in many aspects that affect both consumers and real estate agents.

For example, given the vast quantity of real estate agents in the market, sellers of real estate property who wish to employ the services of a real estate agent may encounter difficulties in selecting a suitable agent. Existing tools may provide evaluations and reviews of real estate agents to assist these potential sellers in making their selection. However, these tools are often only focused on one particular facet of real estate agent performance such as transaction history. In maintaining such a myopic focus, these tools ignore other important aspects of real estate agent performance that should be considered when diligently selecting a real estate agent.

Further, consumers who use network-based real estate services may be assigned to a particular real estate agent who is responsible for fostering a business relationship with the consumers to ensure that they stay committed to engaging in real estate transactions using the real estate agent. Given the large amount of consumers that utilize these services, real estate agents may be overwhelmed with the number of consumers for which they are responsible. As a result, the quality of a real estate agent's work product may suffer and the real estate agent's job performance may be reduced.

### BRIEF DESCRIPTION OF THE DRAWINGS

Various ones of the appended drawings merely illustrate example embodiments of the present invention and cannot be considered as limiting its scope.

FIG. 1 is a block diagram illustrating an abstract view of various functional components of a real estate marketing platform, according to an example embodiment.

FIG. 2 is a block diagram illustrating an architectural view of a networked real estate marketing platform, according to an alternative embodiment, having a client-server architecture configured for exchanging data over a network.

FIG. 3 is a high-level entity-relationship diagram, illustrating various tables that may be maintained within a database of the real estate marketing platform, according to an example embodiment.

FIG. 4 is a block diagram illustrating various functional modules of a performance monitoring application, which is provided as part of the real estate marketing platform, consistent with some embodiments.

FIG. 5 is a flowchart illustrating a method for determining an agent composite rating, according to an example embodiment.

FIG. 6 is a flowchart illustrating a method of calculating an agent engagement score, according to an example embodiment.

FIG. 7 is a flowchart illustrating a method of calculating a prospecting score, according to an example embodiment.

FIG. 8 is a flowchart illustrating a method for notifying a real estate agent supervisor of low performance of a real estate agent, according to an example embodiment.

FIG. 9 is an interface diagram illustrating an interface for provisioning notifications of low performance of a real estate agent, according to an example embodiment.

FIG. 10 is a flowchart illustrating a method for providing indicators of high performance by a real estate agent, according to an example embodiment.

FIG. 11 is an interface diagram illustrating multiple real estate agent profiles, according to an example embodiment.

FIG. 12 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

Aspects of the present disclosure relate to determining ratings for real estate agents. Example embodiments involve a real estate marketing platform that provides various real estate marketing services to both consumer users (also referred to herein as “consumers”) and real estate agent users (also referred to herein as “real estate agents” or simply “agents”). In example embodiments, agent ratings may be determined using various pieces of information about real estate agents such as, for example, actions performed by real estate agents while utilizing the services provided by a real estate marketing platform, real estate agent interactions with consumers, and real estate property transaction histories of real estate agents. For purposes of the present disclosure and the claims, the terms “property,” and “real estate property” shall be synonymous and may refer to any house or structure and the land on which they sit or a piece of undeveloped land including any natural resources (e.g., crops, minerals, or water) located on the land.

Example embodiments involve the calculation of various scores that represent multiple different performance parameters of real estate agents. For example, some embodiments involve the calculation of an agent engagement score that represents a real estate agent's level of engagement with the real estate marketing platform. In this manner, the agent engagement score functions to provide a short term indicator of the performance of the real estate agent. For example, a marked change in an agent's engagement score may be an indication of the agent potentially quitting, and as such, the change may be presented to a supervisor of the agent so that the supervisor may make contact with the agent.

Also, some embodiments may involve the calculation of a prospecting score that represents a level of interaction provided by a real estate agent to consumers. In this manner, the prospecting score functions to provide a leading indicator of future success of the real estate agent. Additionally, some embodiments may include the calculation of a transactional score that reflects a real estate agent's economic value based on performance in real estate transactions. In this manner, the transactional score functions to provide a trailing indicator of the success of the real estate agent. These scores—agent engagement, prospecting, and transactional—may be used either separately or in various combinations to determine a composite agent rating that represents an overall performance of an agent. The agent composite ratings may, in turn, be used by supervisors (e.g., a broker manager) of the real estate agents to monitor agent performance as well as by consumers when selecting a real estate agent to assist in the sale or purchase of property.

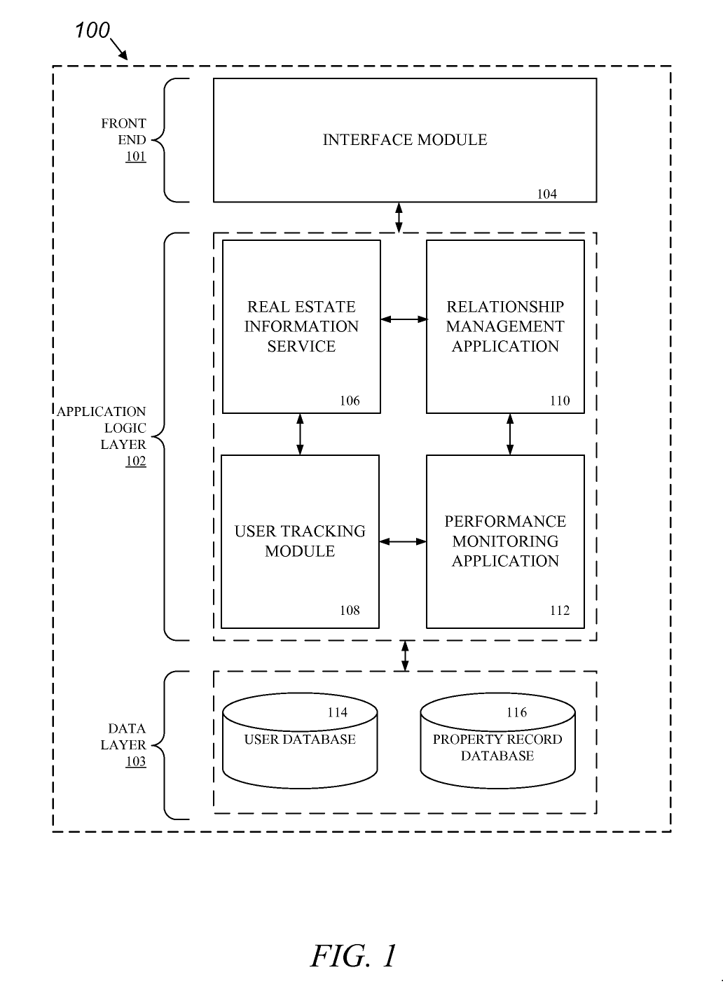

FIG. 1 is a block diagram illustrating an abstract view of various functional components of a real estate marketing platform 100, according to an example embodiment. It will be appreciated that although the functional components of the real estate marketing platform 100 are discussed in the singular sense, multiple instances of each component may be employed. The real estate marketing platform 100 may correspond to a real estate website (e.g., www.ziprealty.com) and may provide various real estate marketing services to both consumers and real estate agents. As shown in FIG. 1, the real estate marketing platform 100 is generally based on a three-tiered architecture, comprising a front-end layer 101, application logic layer 102, and a data layer 103. As is understood by those skilled in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, various additional functional modules and engines may be used with the real estate marketing platform 100 to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer 101 includes an interface module 104 (e.g., a web server and application program interface (API)), which receives requests from various client-computing devices of various users, and communicates appropriate responses to requesting client devices that may include instructions to cause presentation of any one of a plurality of interfaces discussed herein. For example, the interface module(s) 104 may receive requests in the form of Hypertext Transport Protocol (HTTP) requests, or other web-based, API requests. The interface modules 104 may include an API module, which is coupled to and provides programmatic interfaces to the application logic layer 102. In this way, the API module of the interface modules 104 may enable third-party applications to invoke the functionality of the real estate marketing platform 100.

The application logic layer 102 of the real estate marketing platform 100 may include at least one server that includes at least one processing device configured to implement the respective methods discussed herein. As illustrated by FIG. 1, the real estate marketing platform 100 may include a real estate information service 106, a user tracking module 108, relationship management application 110, and a performance monitoring application 112. The real estate information service 106 may host information for real estate properties and may maintain several listings of properties for sale. Each property listing may have a dedicated web page (or a set of web pages) to provide information for each piece of property. This information may include pictures, floor plans, and a geographic area in which the property is located along with other attributes of the property (e.g., price, size, year built, date listed, price per square foot, number of bedrooms, number of bathrooms, and property type). Online property listings may also provide a user with the ability to print the listing, save the listing for later viewing, share the listings with another user, request a visit to the property, request more information about the property, and get directions to the property.

The real estate information service 106 may provide users with the ability to quickly filter, sort, and search through property listings using one or more search parameters. For example, the real estate information service 106 may enable a user to perform a search query for properties within a particular geographic area. As referenced above, the geographic area in which the property is located may be maintained on each property listing page. A geographic area search may, for example, limit the search to property within a particular city, neighborhood, subdivision, postal code, or school district. As another example, the real estate information service 106 may enable a user to perform a search query for properties with certain attributes, which are maintained as part of the corresponding property listing. Attributes of a property may, by way of non-limiting example, include a property type (e.g., single family house, multi-family house, condo, land, or apartment), a size (e.g., square footage), a number of bedrooms, a number of bathrooms, an exact price, a price range, a price decile (e.g., “third decile in market”), a year built, a date listed, a number of days on the market, or a transaction type (e.g., foreclosure, short sale, new construction, tenancy in common, or fixer upper).

The user tracking module 108 may be a hardware implemented module or software executed by general purpose or special purpose hardware or instructions stored on a computer readable medium that is operative to track the activity of users (both consumers and agents) with respect to the real estate marketing platform 100. The user tracking module 108 may store the respective activities of consumer and agents as consumer and agent activity data, respectively (e.g., in user database 114).

The user tracking module 108 may track several types of consumer activity, which are referenced above with respect to the functionalities of the real estate information service 106. The user tracking module 108 may track consumer activity for each consumer of the real estate marketing platform 100 with respect to the functionalities discussed herein. Before being able to engage in certain activities with the real estate information service 106, a consumer may be prompted to set up a user account. Consistent with some embodiments, the consumer activity data may be maintained as part of such a user account maintained by the real estate marketing platform 100.

Consumer activity may, for example, include the following actions: setting up an account, subscribing to alerts or notifications, logging on to an account (e.g., via mobile application or web client), viewing an agent profile page, viewing agent ratings, performing a property search query using location or attribute parameters, saving a property search, viewing an online web page for a property listing, printing a property listing, saving a listing for later viewing, sharing a listing with another user (e.g., via email or social network), requesting or scheduling a visit to a property, requesting more information about a property, requesting directions to a property, performing a geopositional property search query, performing an image-recognition based property search query, or any other actions a consumer may take on a real estate information service 106.

The user tracking module 108 may also track and record agent activity for each agent of the real estate marketing platform 100 with respect to the functionalities discussed herein. The agent activity may, for example, include logging into an account provided by the real estate marketing platform 100, enabling notifications from the real estate marketing platform 100, communicating with or otherwise contacting consumers using tools provided by the real estate marketing platform 100, and other actions related to utilization of the various services provided by the real estate marketing platform 100.

Each consumer (e.g., a buyer or seller) with a user account on the real estate marketing platform 100 may be assigned to an agent. The particular agent assigned to a user may be based on attributes of the agent, activities of the user, a location of the user, a location of the subject property, seasonality or a combination thereof. An agent may be assigned to a group of consumers. As each of the consumers may have different goals and may be at different points in the real estate purchasing process (e.g., casually enquiring as opposed to actively purchasing), providing each consumer with the appropriate level of customer service may be difficult for an agent to manage. To this end, the real estate marketing platform 100 includes a relationship management application 110 that is operative to provide relationship management services to assist agents in managing and communicating with a group of consumers. For example, the relationship management application 110 may automatically segment and classify a group of consumers from a contact pool based on a level of engagement of each of the consumers with the real estate information service 106.

The relationship management application 110 is also responsible for transmitting and routing communication between agents and consumers. The relationship management application 110 may utilize any number of various communication networks and platforms to deliver messages to users. For example, the relationship management application 110 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks. The relationship management application 110 may also provide services to enable efficient communication for agents with consumers. For example, the relationship management application 110 may work in conjunction with the interface module 104 to provide an agent with a dashboard interface for establishing on-going communications with consumers using customizable message scripts.

The performance monitoring application 112 is responsible for determining an agent composite rating for agents of the real estate marketing platform 100, and providing various notifications and indicators of determined ratings. In determining agent composite ratings, the performance monitoring application 112 may calculate multiple scores reflecting various performance parameters of real estate agents based on information about the real estate agent maintained in database 114. For example, the performance monitoring application 112 may calculate agent engagement scores, prospecting scores, and transactional scores.

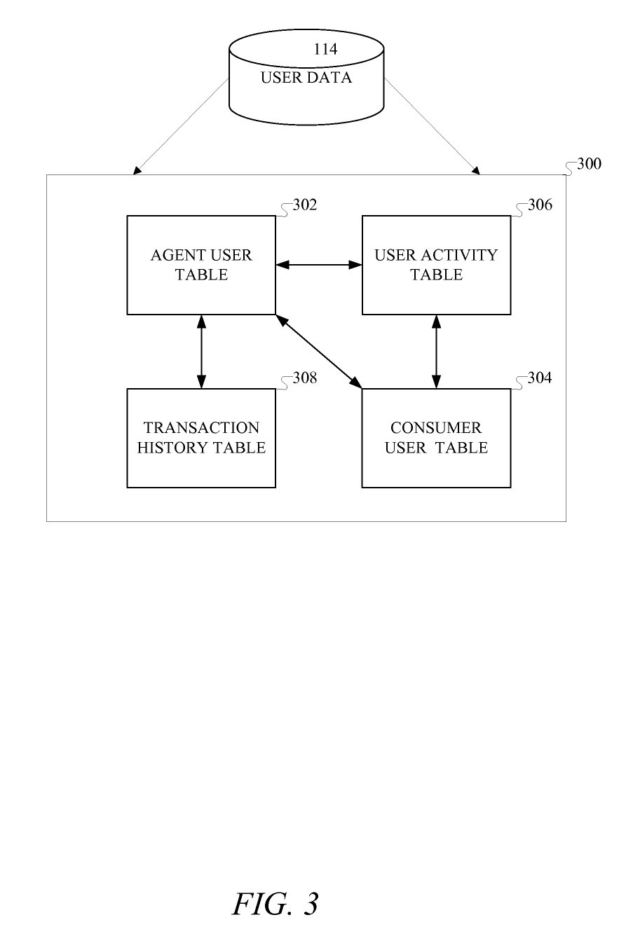

As illustrated in FIG. 1, the application logic layer 102 may be communicatively coupled to the data layer 103. The data layer 103 may include multiple databases, including databases 114 and 116. The user database 114 may store user data including consumer and agent activity information tracked and recorded by the user tracking module 108. Examples of tables stored in the user database 114 will be discussed in greater detail below in reference to FIG. 3.

The property record database 116 may store a record for one or more properties maintained by the real estate information service 106. Each record may include an identifier, an address, or other information pertaining to one or more real estate properties. This information may be maintained for properties that are currently on the market and listed by real estate information service 106 or by a third party server (not shown). The property record database 116 may also include information for other properties that are not currently listed by a listing service and/or are not on the market. The information maintained for each property may include geographic area location information. Geographic area information may, for example, include a state, a city, a postal code, a neighborhood, a county, a school district, or a metropolitan area.

The property record database 116 may also include specific attributes of each property including, for example, a property type (e.g., single family house, multi-family house, condo, land, or apartment), a property size (e.g., square footage), a number of bedrooms, a number of bathrooms, a price, a year built, a date listed, a number of days on the market, and a transaction type (e.g., new, resale, standard, foreclosure, short sale, tenancy in common, or fixer upper).

In one embodiment, property record information for a particular property stored in the user database 114 may be obtained from a user through interface module 104. In another embodiment, property record information for a particular property stored in the property record database 116 may be obtained via the API module from public and private (e.g., multiple listing service (MLS)) property listing databases.

While the real estate information service 106, relationship management application 110, and performance monitoring application 112 are shown in FIG. 1 to form part of the real estate marketing platform 100, it will be appreciated that, in alternative embodiments, any of real estate information service 106, relationship management application 110, and performance monitoring application 112 may form part of or operate in conjunction with a service that is separate and distinct from the real estate marketing platform 100. The various functional components of the application logic layer 102 may also be implemented as standalone systems or software programs, which do not necessarily have networking capabilities. It shall be appreciated that although the various functional components of the real estate marketing platform 100 are discussed in the singular sense, multiple instances of one or more of the various functional components may be employed.

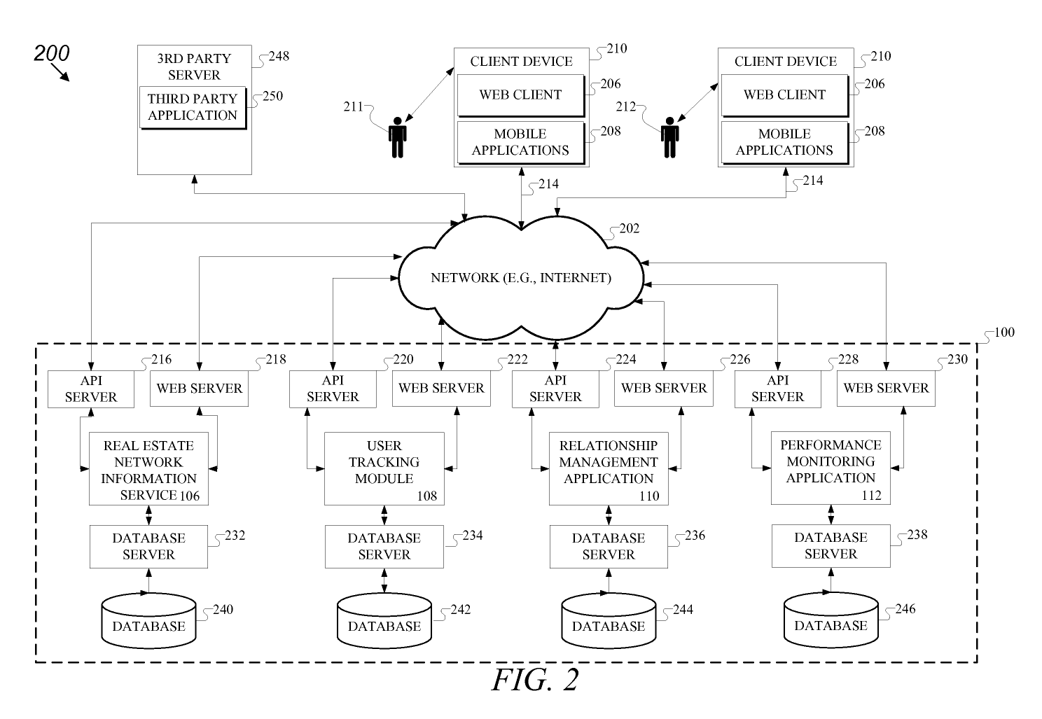

FIG. 2 is a block diagram illustrating an architectural view of the networked real estate marketing platform 100, according to an alternative embodiment, having a client-server architecture configured for exchanging data over a network. It will be appreciated that although the components of the networked real estate marketing platform 100 are discussed in the singular sense, multiple instances of each component may be employed. The real estate marketing platform 100 provides server-side functionality, via a network 202 (e.g., the Internet or wide area network (WAN)), for each real estate information service 106, user tracking module 108, relationship management application 110, and performance monitoring application 112 to one or more clients. For example, FIG. 2 illustrates client devices 210 that represent example devices that can be utilized by users to perform various activities associated with the real estate marketing platform 100. The client devices 210 may be any of a variety of types of devices such as a personal computer, a laptop computer, a cellular telephone, a personal digital assistant (PDA), a personal navigation device (PND), a handheld computer, a tablet computer, a notebook computer, or other type of movable device. As illustrated, the first client device 210 is used by an agent 211, while the second client device 210 is used by a consumer 212.

The client device 210 may be executing conventional web browser applications (e.g., web client 206), or mobile applications 208 that have been developed for a specific platform to include any of a wide variety of mobile devices and operating systems. For example, the client device 210 may be executing a mobile application 208 specifically developed for interacting with the real estate marketing platform 100. The mobile application 208 may provide enhanced search functionality to the consumer 212. For example, the real estate information service 106 may utilize the Global Positioning System (GPS) functionality of the client device 210 to provide the consumer 212 with the ability to perform a geopositional property search query. The geopositional property search query may allow the consumer 212 to perform a property search query for property listings within a specified distance from a location of the consumer 212.

The mobile application 208 may further utilize a camera of (e.g., included in the client device 210) combined with existing image-recognition and geopositioning techniques to provide a user with an image-recognition based property search query. The image-recognition based property search query may identify a property from an image and provide the consumer 212 with the corresponding online property listing. For example, the real estate information service 106 may receive an image of a particular property from the client device 210 of the consumer 212, and based on the recognition of the particular property, the real estate information service 106 may provide the consumer 212 with the corresponding property listing for the particular property. In another example, the real estate information service 106 may receive an image from the client device 210 of a real estate sign associated with a particular property having a unique identifier (e.g., quick response (QR) code or bar code) identifying the particular property. In this example, the real estate information service 106 may provide the consumer 212 with the property listing corresponding to the property based on recognition of the unique identifier.

The client devices 210 may interface via a connection 214 with a communication network 202. Depending on the form of the client devices 210, any of a variety of types of connections 214 and communication networks 202 may be used. For example, the connection 214 may be a Code Division Multiple Access (CDMA) connection, a Global System for Mobile communications (GSM) connection, or other type of cellular connection. Such connection 214 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 202 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks).

In another example, the connection 214 may be Wireless Fidelity (Wi-Fi, IEEE 802.11x type) connection, a Worldwide Interoperability for Microwave Access (WiMAX) connection, or another type of wireless data connection. In such an embodiment, the communication network 202 may include one or more wireless access points coupled to a local area network (LAN), a wide area network (WAN), the Internet, or other packet-switched data network. In yet another example, the connection 214 may be a wired connection, for example an Ethernet link, and the communication network may be a LAN, a WAN, the Internet, or other packet-switched data network. Accordingly, a variety of different configurations are expressly contemplated.

Each API server 216, 220, 224, and 228 and each web server 218, 222, 226 and 230 are coupled to, and provide programmatic and web interfaces to, the real estate information service 106, user tracking module 108, relationship management application 110, and performance monitoring application 112, respectively. The real estate information service 106, user tracking module 108, relationship management application 110, and performance monitoring application 112 are, in turn, shown to be respectively coupled to databases servers 232, 234, 236, and 238 that facilitate access to databases 240, 242, 244, and 246, respectively. The databases 240, 242, 244, and 246 may correspond to the databases 114 and 116 shown in FIG. 1.

As illustrated by FIG. 2, the web client 206 accesses the real estate marketing platform 100 via the web interface supported by each of the web servers 218, 222, 226 and 230, respectively. Similarly, the mobile applications 208 access the various services and functions provided by the real estate information service 106 and modules 108, 110, and 112 via the programmatic interface provided by each of the API servers 216, 220, 224, and 228, respectively.

FIG. 2 also illustrates a third party server 248 as having programmatic access to the network 202. The third party server 248 may be coupled via an API server to the communication network 202, for example, via wired or wireless interfaces. The third party server 248 may, utilizing information retrieved from the communication network 202, support one or more third party applications 250. The third party application 250 may be a website hosted by a third party that supports or utilizes one or more functions or features of the real estate marketing platform 100.

Each of the real estate information service 106, user tracking module 108, relationship management application 110, and performance monitoring application 112 may provide a number of functions and services, as discussed herein, to users that may access each individually. While the real estate information service 106, user tracking module 108, relationship management application 110, and performance monitoring application 112 are shown in FIG. 2 to be separate and distinct modules, it will be appreciated that, in alternative embodiments, the real estate information service 106, user tracking module 108, relationship management application 110, and performance monitoring application 112 may form one integrated networked system, such as the system illustrated by FIG. 1. Further, while the real estate marketing platform 100 shown in FIG. 2 employs a client-server architecture, the present invention is, of course, not limited to such an architecture, and could equally well find application in a distributed, event-driven, or peer-to-peer architecture system, for example. The real estate information service 106, user tracking module 108, relationship management application 110, and performance monitoring application 112 could also be implemented as standalone software programs, which do not necessarily have networking capabilities.

FIG. 3 is a high-level entity-relationship diagram illustrating various tables 300 that may be maintained within the user databases 114. In particular, the tables 300 may include an agent user table 302, a consumer user table 304, a user activity table 306, and a transaction history table 308. The agent user table 302 contains a record for each real estate agent of the real estate marketing platform 100, and may include an identifier of the agent such as a name, a username, an email address, a realtor license number, or some other unique numerical identifier. The consumer user table 304 contains a record for each consumer that has interacted with the real estate marketing platform 100. The consumer user table 304 may include an identifier for each user such as a name, a username, an email address or unique numerical identifier. The consumer user table 304 may further include at least one consumer classification for each user. The consumer classifications may, for example, include a closed client, a transacting client, an offering client, a listing client, a showing client, a pre-listing client, a responsive prospect, an unresponsive prospect, a cold prospect, a reassigned lead, or a new lead. Each consumer for which a record is maintained in the consumer user table 304 may be linked to one or more records of the agent user table 302, so as to associate a consumer with an assigned agent.

The user activity table 306 maintains a record of user activity for users (e.g., consumers and agents) of the real estate marketing platform. In some embodiments, the user activity table 306 stores a historical record of consumer activity for each consumer that has interacted with the real estate marketing platform 100. The consumer activity includes actions performed by consumers while using the real estate marketing platform 100. The user activity table 306 may include an aggregate value for the number of times certain actions are performed. For example, the user activity table 306 may include a total number of times a particular property attribute was used as a parameter in a property search query, a total number of times a particular geographic area was used as a parameter in a property search query, a total number of page views of an online web page for a property listing, a total number of times a property listing was printed, a total number of times a property listing was saved for later viewing, a total number of times a property listing was shared with another user, a total number of requests to view a property, a total number of requests for more information about a property, or a total number of requests for directions to a property.

In some embodiments, the user activity table 306 stores historical records of agent activity for agents of the real estate marketing platform 100. The agent activity includes actions performed by real estate agents while using the real estate marketing platform 100. The records may include an identifier of each action performed as well as an indication of the timing of performance of the action. The user activity table 306 may maintain an aggregate value for the number of times certain actions are performed as well as a record of elapsed time between performance of certain actions (e.g., time taken to respond to a message from a consumer). Entries in the user activity table 306 may be linked to one or more records of the consumer user table 304 and an agent user table 302, so as to provide a record of user activity for each user (consumers and agents) of the real estate marketing platform 100. Entries in the user activity table 306 may also be linked to one or more records of the property record database 116, so as to maintain an association between user actions and properties involved in those actions.

The transaction history table 308 stores a historical record of real estate transaction involving agents of the real estate marketing platform 100. Entries within the transaction history table 308 may include a property identifier (e.g., an address), a closing price, property attributes, and other information pertinent to real estate transactions. The involvement by the real estate agents may be in the purchasing or selling of the property. Entries in the transaction history table 308 may be linked to one or more entries in the agent user table 302 so as to maintain a transactional history for each agent of the real estate marketing platform 100.

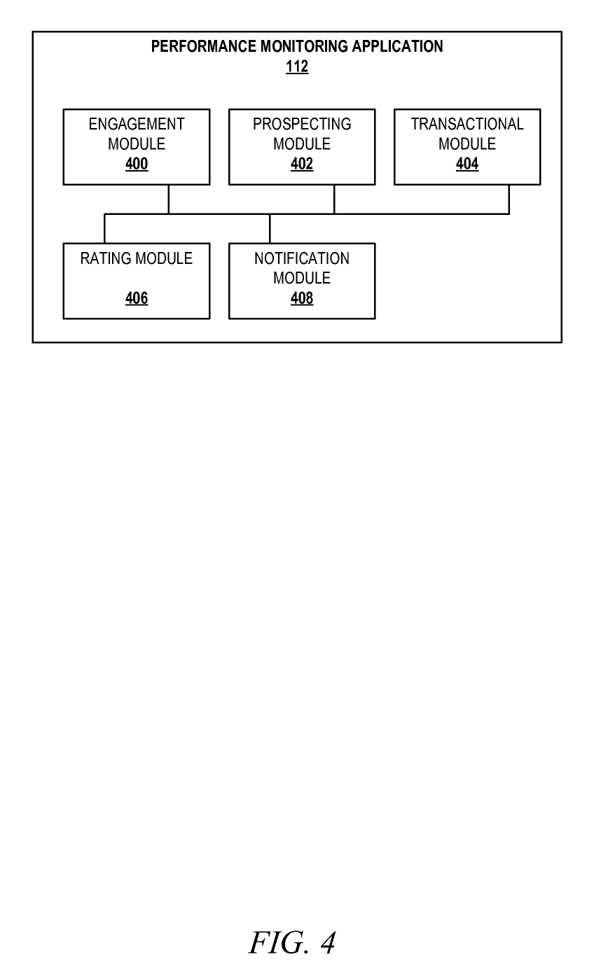

FIG. 4 is a block diagram illustrating various functional modules of the performance monitoring application 112, which is provided as part of the real estate marketing platform 100, consistent with some embodiments. The performance monitoring application 112 is illustrated to include an engagement module 400, a prospecting module 402, a transactional module 404, a rating module 406, and a notification module 408, all configured to communicate with each other (e.g., via a bus, shared memory, a switch, or application programming interfaces (APIs)). The various modules 400-408 of the performance monitoring application 112 may, furthermore, access the databases 114 and 116, and each of the various modules of the performance monitoring application 112 may be in communication with one or more of the third party applications 250. Further, while the modules 400-408 of FIG. 4 are discussed in the singular sense, it will be appreciated that in other embodiments multiple modules may be employed.

The engagement module 400 may be a hardware implemented module or software executed by general purpose or special purpose hardware or instructions stored on a computer readable medium that is operative to calculate real estate agent engagement scores. The engagement scores calculated by the engagement module 400 indicate a level of engagement of a real estate agent with the real estate marketing platform 100. The engagement module 400 may calculate engagement scores based on actions performed by real estate agents that involve interactions with services provided by the real estate marketing platform 100. For example, an agent's engagement score may be based on how often the agent logs into a user account of the real estate marketing platform 100 (either via browser or mobile application), whether the agent has signed up to receive notifications from the real estate marketing platform 100, how many listings have been shared by the agent (e.g., via social networking services used in conjunction with the real estate marketing service), how many comments have been left by the agent on property listings, updates made to the agent's profile, how many contacts are included in the agent's list of contacts, and how many services provided by the real estate marketing platform 100 are utilized by the agent. A record of such actions may be maintained as part of agent activity data in the user activity table 306 of the user database 114.

The prospecting module 402 may be a hardware implemented module or software executed by general purpose or special purpose hardware or instructions stored on a computer readable medium that is operative to calculate prospecting scores for real estate agents of the real estate marketing platform 100. The prospecting scores calculated by the prospecting module 402 indicate a level of interaction provided by real estate agents to consumers of the real estate marketing platform 100. The prospecting module 402 may calculate prospecting scores based on actions performed by real estate agents that involve interactions with consumers of the real estate marketing platform 100. For example, an agent's prospecting score may be based on how many consumers have been contacted by the agent, how many communications (e.g., phone calls, emails, or text messages) have been sent out by or on behalf of the agent, how many high value consumers have been contacted by the agent, and how quickly the agent responds to messages from consumers. A record of such actions may be maintained as part of agent activity data in the user activity table 306 of the database 114.

The transactional module 404 may be a hardware implemented module or software executed by general purpose or special purpose hardware or instructions stored on a computer readable medium that is operative to calculate transactional scores for real estate agents of the real estate marketing platform 100. A transactional score calculated by the transactional module 404 provides a measure of the economic value that the real estate agent's business provides to the real estate marketing platform 100. The transactional scores calculated by the transactional module 404 may be based on the transaction history (e.g., stored in user database 114) of the real estate agent. For example, the transactional score of a real estate agent may be based on how many transactions the agent has closed, the total selling price of all transactions the agent has closed, how many property offers have been made by the real estate agent (on behalf of clients), how many showings have been performed by the agent, how many consumers classified as leads the agent has converted to prospects or clients, how many consumers classified as prospects the agent has converted to clients, and the number of property listings the agent is responsible for.

The rating module 406 may be a hardware implemented module or software executed by general purpose or special purpose hardware or instructions stored on a computer readable medium that is operative to determine agent composite ratings for real estate agents of the real estate marketing platform 100. The agent composite rating provides an indication of the overall performance of the agent. The agent composite rating may be determined by aggregating various combinations of the engagement, prospecting, and transactional scores.

The notification module 408 may be a hardware implemented module or software executed by general purpose or special purpose hardware or instructions stored on a computer readable medium that is operative to provide notifications to users of the real estate marketing platform 100. Notifications provided by the notification module 408 may relate to actions of other users on the real estate marketing platform 100. For example, the notification module 408 may notify an agent when a consumer views the agent profile of the agent. In another example, the notification module 408 may notify an agent's supervisor that the agent's composite rating has dropped below a predefined threshold. In this example, the notification may further include advice or suggestions as to training that may improve the agent's performance.

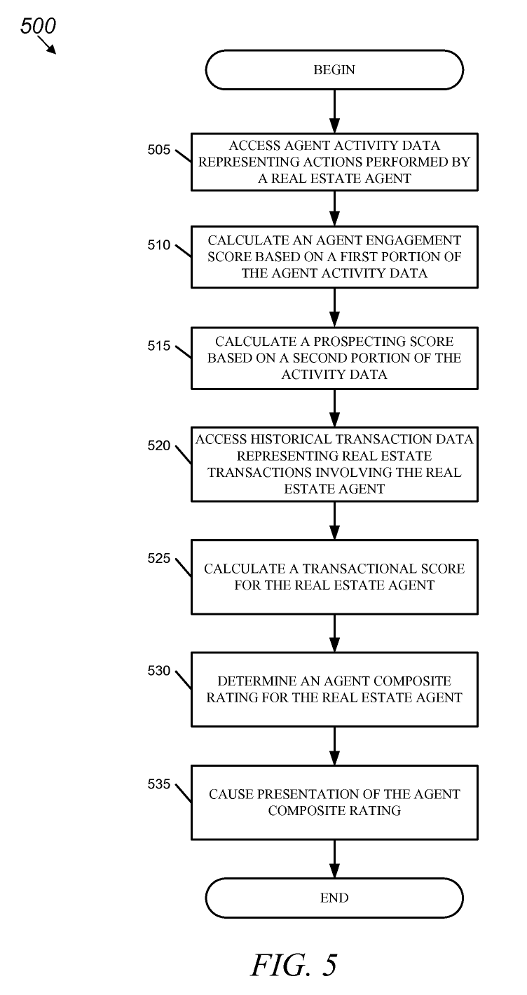

FIG. 5 is a flowchart illustrating a method 500 for determining an agent composite rating, according to an example embodiment. The method 500 may be embodied in computer-readable instructions for execution by one or more processors such that the steps of the method 500 may be performed in part or in whole by the performance monitoring application 112. In particular, the method 500 may be carried out by the modules forming the performance monitoring application 112, and accordingly, the method 500 is described below by way of example with reference thereto. However, it shall be appreciated that the method 500 may be deployed on various other hardware configurations and is not intended to be limited to the modules of the performance monitoring application 112.

At operation 505, the engagement module 400 and prospecting module 402 access agent activity data representing actions performed by a real estate agent while using services provided by the real estate marketing platform 100. The agent activity data may be stored in the user database 114.

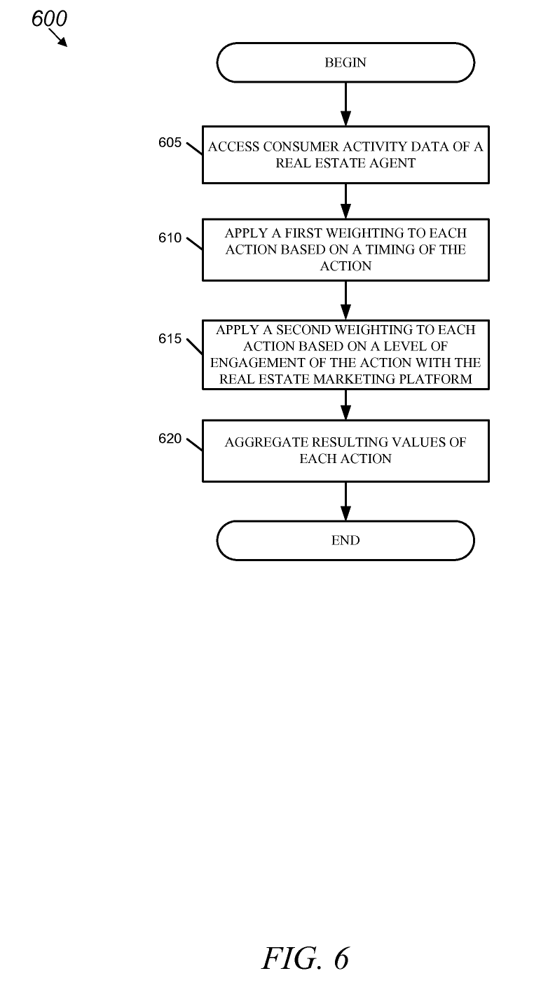

At operation 510, the engagement module 400 calculates an engagement score for the real estate agent based on a first portion of the agent activity data. The first portion of the agent activity data comprises actions of the real estate agent involving interaction with the real estate marketing platform 100. In this way, the engagement score indicates a level of engagement of the real estate agent with the network-based real estate service. Further details regarding the process of calculating an agent engagement score are described below with reference to FIG. 6.

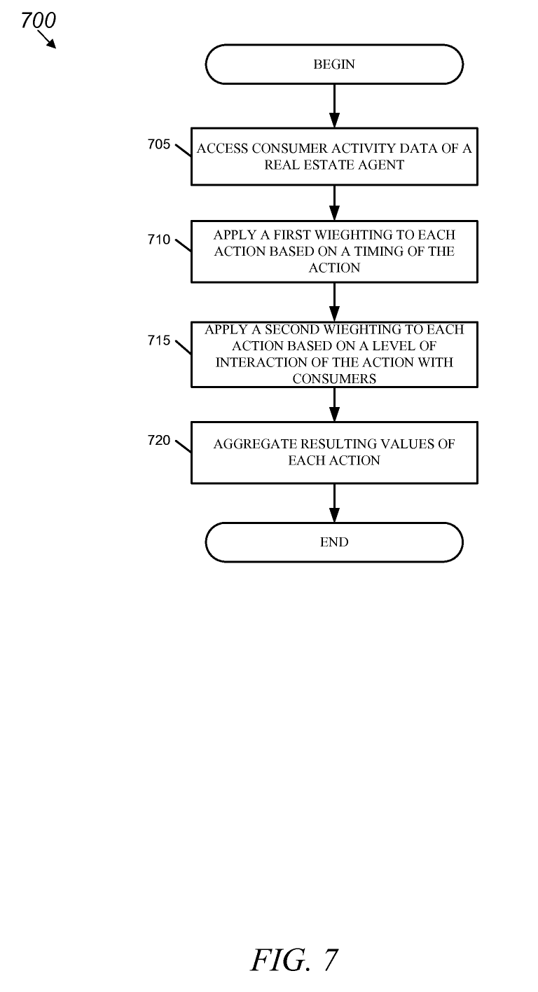

At operation 515, the prospecting module 402 calculates a prospecting score for the real estate agent based on a second portion of the agent activity data. The second portion of the agent activity data comprises actions of the real estate agent involving interaction with consumers of the real estate marketing platform 100. In this way, the prospecting score provides an indicator of a level of interaction provided by the real estate agent to consumers of the real estate marketing platform 100. Further details regarding the process of calculating an agent engagement score are described below with reference to FIG. 7.

At operation 520, the transaction module 404 may access historical transaction data (e.g., stored in the user database 114) representing real estate transactions involving the real estate agent. At operation 525, the transactional module 404 may calculate a transactional score for the real estate agent. The transactional score represents a value (e.g., a monetary value) provided by the real estate agent to the real estate marketing platform 100. The calculation of the transactional score by the transactional module 404 may, for example, be based on a number of transactions closed by the agent, a transaction volume (e.g., dollar value) of the real estate agent, a number of offers entered by the agent, a number of showings performed by the agent, a number of property listings the agent is responsible for, a number of consumer leads the agent has converted to property showings, and a number of consumer leads the agent has converted to closed transactions. The operations 520 and 525 are optional and may not be performed in some embodiments.

At operation 530, the rating module 406 determines an agent composite rating for the real estate agent. The agent composite rating may be based on combinations of the engagement, prospecting, and transactional scores. The rating module 406 may, for example, determine the agent composite rating by calculating the sum of the engagement, prospecting, and transactional scores, or by determining a statistical summation (e.g., mean, mode, or average) of the engagement, prospecting, and transactional scores. In some embodiments, the transactional score may not be taken into account when calculating the agent composite rating. The agent composite rating may be a numerical value or other suitable indicator for expressing ratings. At operation 535, the user interface modules 104 may cause presentation of the engagement score, prospecting score, transactional score, and agent composite rating. The engagement score, prospecting score, transactional score, and agent composite rating may, in some embodiments, be presented as part of an agent profile of the real estate agent.

It shall be appreciated that the method 500 may be routinely performed for each real estate agent of the real estate marketing platform 100 so as to maintain a current composite agent rating for each real estate agent. Further, in some embodiments, an updated agent composite rating for a real estate agent may be determined in response to detecting a new action being performed by the real estate agent while using a service provided by the real estate marketing platform 100.

FIG. 6 is a flowchart illustrating a method 600 of calculating an agent engagement score, according to an example embodiment. The method 600 may be embodied in computer-readable instructions for execution by one or more processors such that the steps of the method 600 may be performed in part or in whole by the performance monitoring application 112. In particular, the method 600 may be carried out by the engagement module 400, and accordingly, the method 600 is described below by way of example with reference thereto. However, it shall be appreciated that the method 600 may be deployed on various other hardware configurations and is not intended to be limited to the engagement module 400 of the performance monitoring application 112.

At operation 605, the engagement module 400 accesses agent activity data of a real estate agent (e.g., from the user database 114) representative of activity (e.g., one or more actions performed while using services provided by the real estate marketing platform 100) of the real estate agent. In particular, the engagement module 400 may access a particular subset of the agent activity data that represents actions involving direct interaction with the real estate marketing platform 100. For example, the engagement module 400 may access agent activity data representing the agent's actions of signing-in to an account maintained by the real estate marketing platform 100, signing up to receive notifications from the real estate marketing platform 100, writing comments about a property listing, updating an agent profile, updating an agent profile picture, adding social media credentials to an agent profile, sharing property listings using social media, and utilizing marketing services provided by the real estate marketing platform 100.

At operation 610, the engagement module 400 applies a first weighting to each action included in the agent activity data based on a timing of each action. For example, the engagement module 400 may assign a first value to each action based on a timing of performance of the action. In this manner, the engagement module 400 weights each of the agent's actions according to how recently they performed the action. In an example, the engagement module 400 may assign actions performed within the previous six days with a value of 4, actions performed in the last seven to thirteen days with a value of 2, actions performed in the last fourteen to twenty days with a value of 1, actions performed in the last 21-27 days with a value of 0.5, and actions performed in the last 28-30 days with a value of 0.25.

At operation 615, the engagement module 400 applies a second weighting to each action based on a level of engagement of the action with the real estate marketing platform 100. For example, the engagement module 400 may multiply the first value assigned to each action by a second value. In this way, each of the actions performed by the agent is provided additional weight based on the amount of active participation involved in the action. An activity that shows a high level of engagement, such as utilizing marketing services provided by the real estate marketing platform 100, will be weighted higher than a less engaged activity such as signing in to an a user account. The result of the application of the second value to the first value is a third value that provides an overall weighting for each action based on a combination of how recently the action was performed and level of engagement.

At operation 620, the engagement module 400 may aggregate (e.g., sum) the respective resulting values (e.g., the third value) for each action to calculate the engagement score of the agent. In some embodiments, the interface module 104 may cause the engagement score to be presented (e.g., on client device 210). For example, the engagement scores for each agent of the real estate marketing platform 100 may be displayed in a list that may be filtered, ranked, or sorted according to the engagement score.

FIG. 7 is a flowchart illustrating a method 700 for calculating a prospecting score, according to an example embodiment. The method 700 may be embodied in computer-readable instructions for execution by one or more processors such that the steps of the method 700 may be performed in part or in whole by the performance monitoring application 112. In particular, the method 700 may be carried out by the prospecting module 402, and accordingly, the method 700 is described below by way of example with reference thereto. However, it shall be appreciated that the method 700 may be deployed on various other hardware configurations and is not intended to be limited to the prospecting module 402 of the performance monitoring application 112.

At operation 705, the prospecting module 402 may access agent activity data of a real estate agent (e.g., from the user database 114) representative of activity (e.g., one or more actions performed while using services provided by the real estate marketing platform 100) of the real estate agent. In particular, the prospecting module 402 may access a particular subset of the agent activity data that represents actions involving interaction with consumers of the real estate marketing platform 100. For example, the prospecting module 402 may access agent activity data representing communications (e.g., telephone calls, emails, text messages, facsimile transmissions, or letters) sent by or on behalf of the agent to consumers, responses sent to communications received from consumers, bulk email messages sent to a group of consumers, and conversions of unresponsive consumers to responsive consumers. In some embodiments, the agent activity data accessed by the prospecting module 402 may further include an indication of response time for communication sent by the agent in response to communications received by consumers. Further, the agent activity data accessed by the prospecting module 402 may further include an indication of a number of high value consumers contacted by the agent.

At operation 710, the prospecting module 402 applies a first weighting to each action included in the agent activity data based on a timing of each action. For example, the prospecting module 402 may assign a first value to each action based on a timing of the performance of the action. In this manner, the prospecting module 402 weights each of the agent's actions according to how recently the action was performed. In one example, the engagement module 400 may assign actions performed within the previous six days with a value of 4, actions performed in the last seven to thirteen days with a value of 2, actions performed in the last fourteen to twenty days with a value of 1, actions performed in the last 21-27 days with a value of 0.5, and actions performed in the last 28-30 days with a value of 0.25.

At operation 715, the prospecting module 402 may apply a second weighting to each action based on a level of interaction (between the real estate agent and a consumer) involved in performing the action. For example, the prospecting module 402 may multiply the first value assigned to each action by a second value. In this way, each of the actions performed by the agent is provided additional weight according to the amount of active interactivity involved in the action. An activity that shows a high level of interaction, such as converting a prospective client to a transacting client, may be weighted higher than a less interactive activity such as sending a scripted welcome email message to a new consumer. The result of the application of the second value to the first value is a third value that provides an overall weighting for each action based on a combination of how recently the action was performed and level of interaction.

At operation 720, the prospecting module 402 may aggregate (e.g., sum) the respective resulting values (e.g., the third value) for each action to calculate the prospecting score of the real estate agent. In some embodiments, the interface module 104 may cause the prospecting score to be presented (e.g., on client device 210). For example, the prospecting scores for each agent of the real estate marketing platform 100 may be displayed in a list that may be filtered, ranked, or sorted according to the prospecting score.

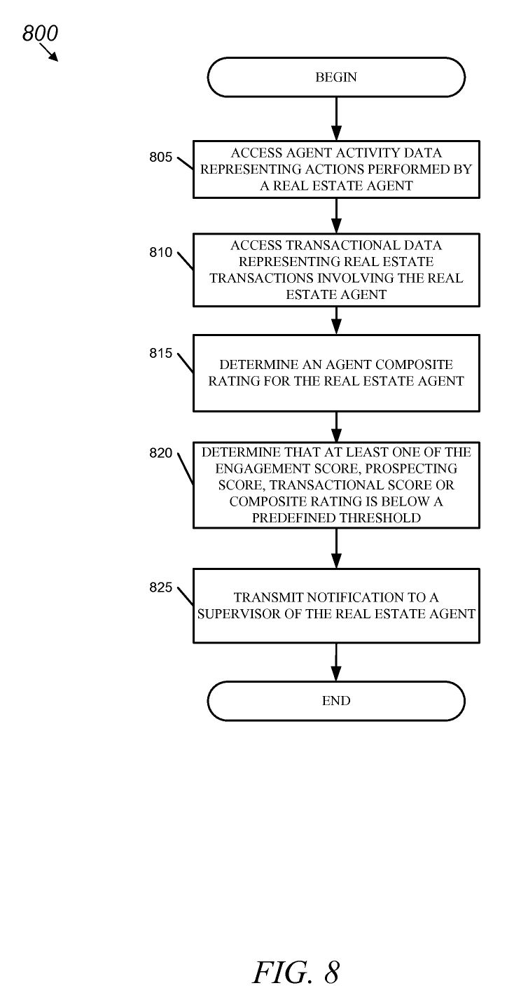

FIG. 8 is a flowchart illustrating a method for notifying a real estate agent supervisor of low performance of a real estate agent, according to an example embodiment. The method 800 may be embodied in computer-readable instructions for execution by one or more processors such that the steps of the method 800 may be performed in part or in whole by the performance monitoring application 112. In particular, the method 800 may be carried out by the modules forming the performance monitoring application 112, and accordingly, the method 800 is described below by way of example with reference thereto. However, it shall be appreciated that the method 800 may be deployed on various other hardware configurations and is not intended to be limited to the modules of the performance monitoring application 112.

At operation 805, the engagement module 400 and prospecting module 402 access agent activity data (e.g., stored in database user 114) representing actions performed by a real estate agent while using services provided by the real estate marketing platform 100. At operation 810, the transaction module 404 accesses historical transaction data (e.g., stored in the user database 114) representing real estate transactions involving the real estate agent.

At operation 815, the rating module 406, in conjunction with the engagement module 400, prospecting module 402, and transactional module 404, may determine an agent composite rating for the real estate agent based on the agent activity data and the historical transaction data. In some embodiments, the rating module 406 may determine the agent composite rating using engagement, prospecting, and transactional scores calculated by the engagement module 400, prospecting module 402, and transactional module 404, respectively. Further details regarding determination of the agent composite rating are discussed above in reference to an example embodiment illustrated by FIG. 5.

At operation 820, the rating module 406 determines that at least one of the engagement score, prospecting score, transactional score, or the agent composite rating is below a predefined threshold. The predefined threshold may be a default value, a value set by an administer of the real estate marketing platform 100, or a value set by a supervisor of the real estate agent. In response to determining that at least one of the engagement score, prospecting score, transactional score, or the agent composite rating is below a predefined threshold, the notification module 408, at operation 825, transmits a notification to a client device of a supervisor of the real estate agent to notify the supervisor of the low engagement score, prospecting score, transactional score, or the agent composite rating of the real estate agent.

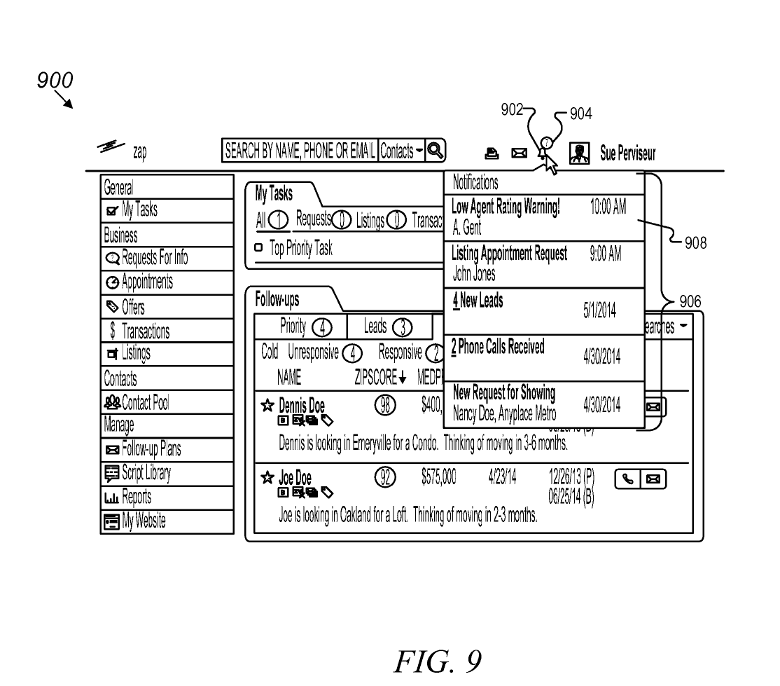

As an example, FIG. 9 is an interface diagram illustrating an interface 900 for provisioning notifications to users of the real estate marketing platform 100, according to an example embodiment. The interface 900 corresponds to one of several interfaces provided to agents by the user interface modules 104 of the real estate marketing platform 100. As shown, the interface 900 includes a notification icon 902, which is presented in the banner of the interface 900. The notification icon 902 includes a notification count 904 to indicate a number of notifications for the viewing agent (e.g., identified in interface 900 as “Sue Perviseur”).

A user (e.g., agent) hovering over or otherwise selecting (e.g., clicking) the notification icon 902, causes the interface module 104 to present a notification list 906. The notification list 906 comprises multiple indicators (e.g., icons) of pending notifications. The notifications may be of varied types and may relate to activities of consumers or agents, received communications, or pending tasks of the agent. For each type of notification, a number may be presented to indicate a number of new notifications of that type. Upon selection of one of the notification indicators presented in the notification list 906, a list of all notifications (old and new) of the particular type may be displayed.

New notifications may be visually distinguished (e.g., bolded, shaded, different color) from old notifications. Notifications may be displayed for a given time period (e.g., seven days). A detail view of a notification may be presented in response to selection of the notification. Notably, the notification list 906 includes a notification 908, which indicates that the agent composite rating (illustrated as “Agent Rating”) of a real estate agent (“A. Gent”) is low (e.g., below a predefined threshold). The viewing agent (e.g., “Sue Perviseur”), who may be the supervisor of the agent with the low agent rating (e.g., “A. Gent”), is notified of the low agent rating of the other agent (e.g., “A. Gent”) so that proper action (e.g., firing, reprimand, or further training) may be taken. In some embodiments, engagement, prospecting, and transactional scores that are below a predefined threshold may also trigger a notification. Other notifications may, for example, include “New Lead,” “Lead Reassigned,” “Listing Appointment Requested,” “Showing Requested,” “Request for Information,” “New Email Received,” “Phone Call Received,” and “New Fax Received.”

In some embodiments, agents may be provided with a number of configurable parameters to define the types of notifications the agent will receive and the manner in which the notifications will be received (e.g., text message, email, or both). It shall be appreciated that although the notification icon 902 and notification list 906 are illustrated as being part of the interface 900, the notification icon 902 and notification list 906 are not limited to the interface 900, and may also be included with any of the several interfaces provided by the real estate marketing platform 100. Further, in some embodiments, the notification list 906 may be displayed as an independent screen in a mobile application (e.g., mobile application 208) designed for use with the real estate marketing platform 100.

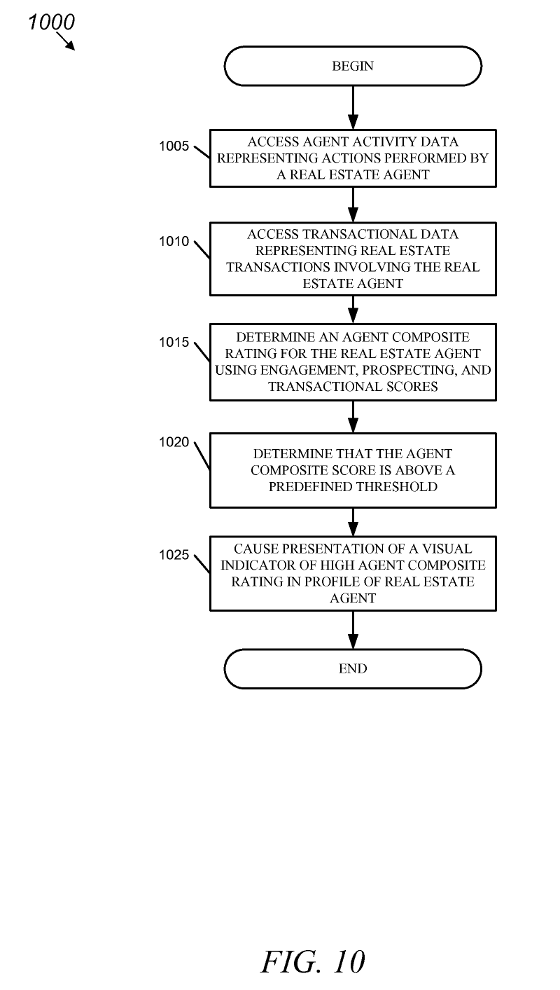

FIG. 10 is a flowchart illustrating a method for providing indicators of high performance by a real estate agent, according to an example embodiment. The method 1000 may be embodied in computer-readable instructions for execution by one or more processors such that the steps of the method 1000 may be performed in part or in whole by the performance monitoring application 112. In particular, the method 1000 may be carried out by the modules forming the performance monitoring application 112, and accordingly, the method 1000 is described below by way of example with reference thereto. However, it shall be appreciated that the method 1000 may be deployed on various other hardware configurations and is not intended to be limited to the modules of the performance monitoring application 112.

At operation 1005, the engagement module 400 and prospecting module 402 access agent activity data (e.g., stored in user database 114) representing actions performed by a real estate agent while using services provided by the real estate marketing platform 100. At operation 1010, the transactional module 404 accesses historical transactional data (e.g., stored in the user database 114) representing real estate transactions involving the real estate agent.

At operation 1015, the rating module 406, in conjunction with the engagement module 400, prospecting module 402, and transactional module 404, may determine an agent composite rating for the real estate agent based on the agent activity data and the historical transaction data. In some embodiments, the rating module 406 may determine the agent composite rating using engagement, prospecting, and transactional scores calculated by the engagement module 400, prospecting module 402, and transactional module 404, respectively. Further details regarding the determination of the agent composite rating are discussed above in reference to an example embodiment illustrated by FIG. 5.

At operation 1020, the rating module 406 determines that the agent composite rating is above a predefined threshold. The predefined threshold may be a default value, a value set by an administer of the real estate marketing platform 100, or a value set by a supervisor of the real estate agent. In response to determining that the agent composite rating is above the predefined threshold, the rating module 406 may, in conjunction with the interface module 104, cause presentation (e.g., on a client device operated by a consumer) of a visual indicator of a high agent composite rating in a profile of the real estate agent.

In some embodiments, the rating module 406 may, at operation 1020, instead determine that one or more of the engagement score, prospecting score, and transactional score are above a predefined threshold. The rating module 406 may, accordingly, cause presentation (e.g., on a client device operated by a consumer) of a visual indicator of a high engagement score, prospecting score, or transactional score, at operation 1025.

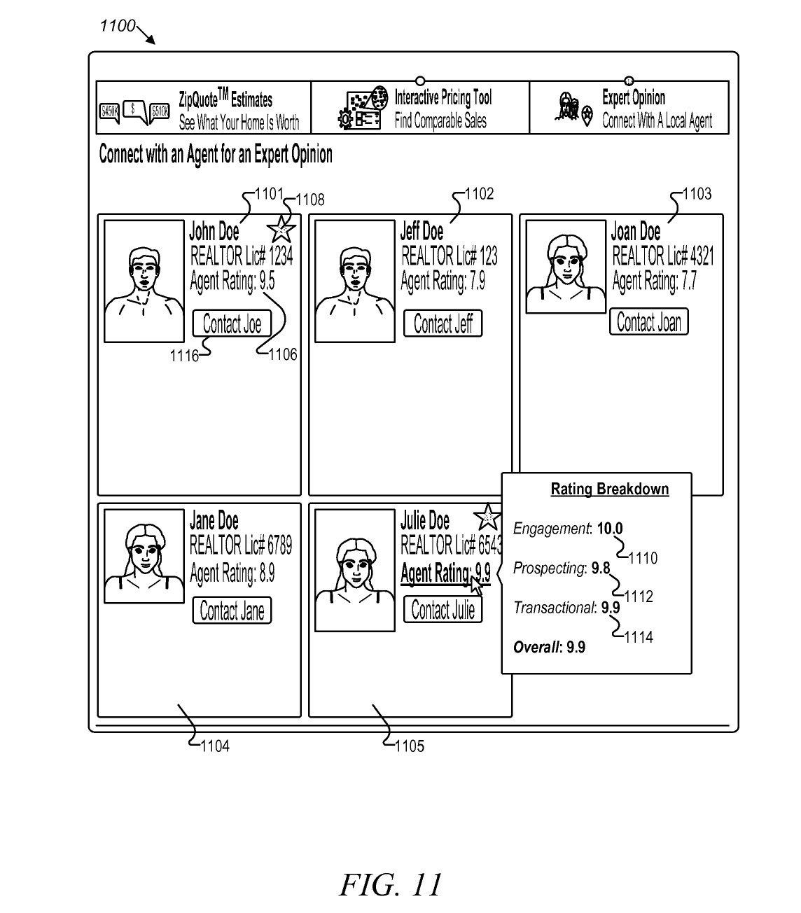

As an example, FIG. 11 is an interface diagram illustrating an interface 1100 having multiple real estate agent profiles, according to an example embodiment. As shown, the interface 1100 includes agent profiles 1101-1105. Each of the agent profiles 1101-1105 may include, at least, the agent's name, a picture of the agent, and an additional identifier (e.g., a realtor license number). In some instances, the agent profiles may also include an indicator of a user based rating of the agent and a selection of user reviews.

Each of the agent profiles 1101-1105 may also include an agent rating (e.g., the agent composite rating), which provides a measure of an overall performance of the agent. For example, agent profile 1101 includes agent rating 1106, which in this case is 9.5. The profiles of agents with high agent composite ratings may further include a visual indicator 1108 signifying the high level of performance exhibited by the agent. Visual indicators such as visual indicator 1108 may be included in agent profiles or other such listings in response to the agent composite rating of the agent exceeding a predefined threshold, consistent with some embodiments.

As illustrated in FIG. 11, a user viewing the interface 1100 may cause the interface module 104 to present detailed information (illustrated as “Rating Breakdown”) regarding agent ratings by hovering over or otherwise selecting (e.g., clicking) on the displayed agent rating. The detailed information may be displayed in a pop-up window and may include engagement score 1110, prospecting score 1112, and transactional score 1114.

Each of the agent profiles 1101-1105 may also include a button (e.g., button 1116) or other graphical element to invoke functionality to communicatively connect the user with a desired agent. Upon invocation of one of these graphical elements (e.g., a user clicking the button 1116), the user may be communicatively coupled with the corresponding agent via email, phone call, text message, instant message, SMS, social network communication, or the like.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Machine Architecture and Machine-Readable Medium

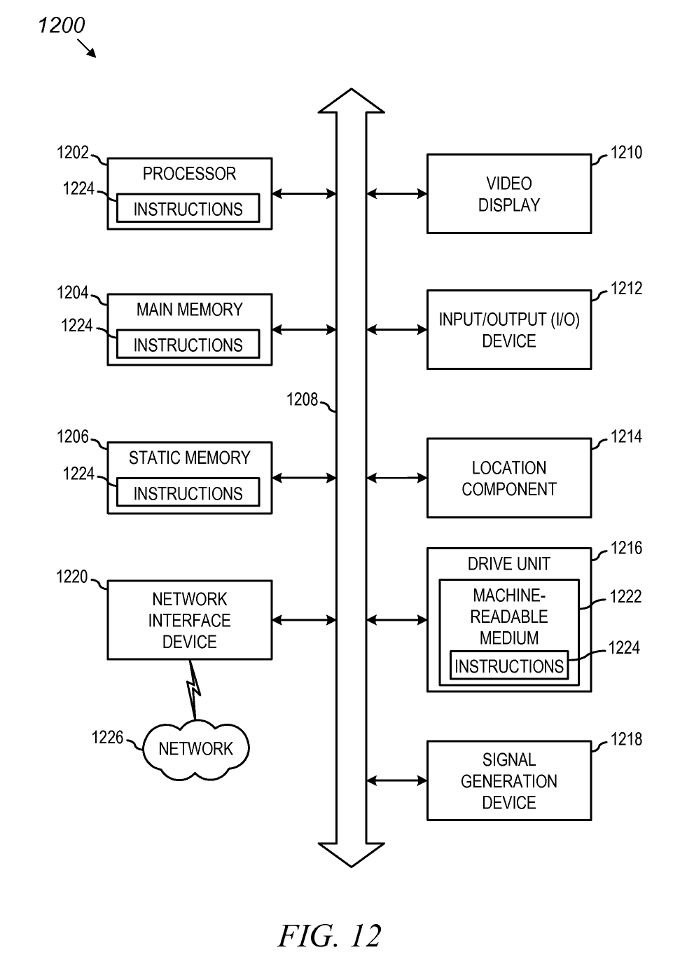

FIG. 12 is a block diagram of a machine in the example form of a computer system 1200 within which instructions 1224 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions 1224 to perform any one or more of the methodologies discussed herein. Consistent with some embodiments, the computer system 1200 may correspond to the client devices 210 and 212, the third party server 248 or any of the servers 216-238.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes one or more input/output (I/O) devices 1212, a location component 1214 (e.g., a GPS device), a disk drive unit 1216, a signal generation device 1218 (e.g., a speaker) and a network interface device 1220. The one or more I/O devices 1212 may, for example, include a keyboard, a mouse, a keypad, a multi-touch surface (e.g., a touchscreen or track pad), a microphone, a camera, or the like.

The location component 1214 may be used for determining a location of the computer system 1200. In some embodiments, the location component 1214 may correspond to a GPS transceiver that may make use of the network interface device 1220 to communicate GPS signals with a GPS satellite. Consistent with some embodiments, the location component 1214 may also be configured to determine a location of the computer system 1200 by using an internet protocol (IP) address lookup or by triangulating a position based on nearby mobile communications towers. The location component 1214 may be further configured to store a user-defined location in main memory 1204 or static memory 1206. In some embodiments, a mobile location-enabled application may work in conjunction with the location component 1214 and the network interface device 1220 to transmit the location of the computer system 1200 to an application server or third party server 248 for the purpose of identifying the location of a user operating the computer system 1200.

In some embodiments, the network interface device 1220 may correspond to a transceiver and antenna. The transceiver may be configured to both transmit and receive cellular network signals, wireless data signals, or other types of signals via the antenna, depending on the nature of the computer system 1200.

### Machine-Readable Medium

The disk drive unit 1216 includes a machine-readable medium 1222 on which is stored one or more sets of data structures and instructions 1224 (e.g., software) embodying or used by any one or more of the methodologies or functions described herein. The instructions 1224 may also reside, completely or at least partially, within the main memory 1204, static memory 1206, and/or within the processor 1202 during execution thereof by the computer system 1200, the main memory 1204, static memory 1206 and the processor 1202 also constituting machine-readable media 1222.

Consistent with some embodiments, the instructions 1224 may relate to the operations of an operating system. Depending on the particular type of the computer system 1200, the OS may, for example, be the iOS® operating system, the Android® operating system, a BlackBerry® operating system, the Microsoft® Windows® Phone operating system, Symbian® OS, or webOS®. Further, the instructions 1224 may relate to operations performed by applications (commonly known as “apps”), consistent with some embodiments. One example of such an application is a mobile browser application that displays content, such as a web page or a user interface using a browser.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions 1224 for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks 1226 include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 1224 for execution by the machine, and includes digital or analog communications signals or other intangible media to facilitate communication of such software.

Although the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

What is claimed is:

1. A method comprising:
accessing agent activity data representing one or more actions performed by a real estate agent while using a network-based real estate service;
calculating, using a processor of a machine, a prospecting score for the real estate agent based on a first portion of the activity data, the prospecting score indicating a level of interaction provided by the real estate agent on the network-based real estate service; and
causing presentation of the prospecting score on a client device.

2. The method of claim 1, further comprising calculating an engagement score for the real estate agent based on a second portion of the agent activity data, the engagement score indicating a level of engagement of the real estate agent with the network-based real estate service, the second portion of the activity data corresponding to actions involving interactions with the network-based real estate service.

3. The method of claim 2, further comprising:
accessing historical transaction data of the real estate agent representing one or more real estate transaction involving the real estate agent; and
calculating a transactional score for the real estate agent based on the historical transaction data, the transactional score indicating an economic value provided by the real estate agent to the network-based real estate service.

4. The method of claim 3, further comprising determining an agent composite rating for the real estate agent based on the engagement score, the prospecting score, and the transactional score.

5. The method of claim 1, wherein the calculating of the prospecting score of the real estate agent comprises:
applying a first weighting to each action based on a timing of the action;
applying a second weighting to each action based on a level of interaction of the action, the applying of the second weighting to each action resulting in a weighted value for each action; and
aggregating respective weighted values for each action to determine the agent prospecting score.

6. The method of claim 1, further comprising:
determining that the prospecting score of the real estate agent is below a pre-defined threshold; and
in response to determining that the prospecting score of the real estate agent is below the predefined threshold, transmitting a notification to a supervisor of the real estate agent to notify the supervisor of the prospecting score of the real estate agent.

7. The method of claim 1, wherein the first portion of the activity data corresponds to actions involving interactions with consumers of the network-based real estate service.

8. The method of claim 2, wherein the calculating of the engagement score of the real estate agent comprises:
applying a first weighting to each action based on a timing of the action;
applying a second weighting to each action based on a level of engagement of the action, the applying of the second weighting resulting in a weighted value for each action; and
aggregating respective weighted values for each action to determine the engagement score.

9. The method of claim 4, further comprising
determining that the agent composite rating of the real estate agent is above a predefined threshold; and
in response to determining that the agent composite rating of the real estate agent is above the predefined threshold, causing presentation of an indicator signifying a high agent composite rating.

10. A system comprising:
a processor of a machine;
a machine readable medium storing agent activity data representing one or more actions performed by a real estate agent while using a network-based real estate service;
a prospecting module configured to calculate, using the processor of the machine, a prospecting score for the real estate agent based on a first portion of the activity data, the first portion of the activity data corresponding to actions involving interactions with consumers of the network-based real estate service, the prospecting score indicating a level of interaction provided by the real estate agent to the consumers; and
a user interface module configured to cause presentation of the prospecting score of the real estate agent on a client device.

11. The system of claim 10, further comprising an engagement module configured to calculate an engagement score for the real estate agent based on a second portion of the agent activity data, the engagement score indicating a level of engagement of the real estate agent with the network-based real estate service, the second portion of the activity data corresponding to actions involving interactions with the network-based real estate service.

12. The system of claim 11, further comprising a rating module configured to determine an agent composite rating for the real estate agent by aggregating the engagement score and the prospecting score.

13. The system of claim 12, wherein the rating module is further configured to calculate an updated agent composite rating, wherein the calculating of the updated agent composite rating is performed on a routine basis.

14. The system of claim 10, further comprising a transaction module configured to calculate a transactional score for the real estate agent based on historical transaction data, the transactional score indicating an economic value provided by the real estate agent to the network-based real estate service, the historical transaction data representing one or more real estate transactions involving the real estate agent.

15. The system of claim 11, wherein the engagement score is based on timing and a level of engagement of each action in the second portion of agent activity data.

16. The system of claim 10, wherein the prospecting score is based on timing and a level of interaction of each action in the first portion of the agent activity data.

17. The system of claim 10, further comprising a notification module configured to transmit a notification to a supervisor of the real estate agent to notify the supervisor of a low prospecting score of the real estate agent in response to determining that the prospecting score of the real estate agent is below a predefined threshold.

18. The system of claim 12, wherein the rating module is further configured to
determine that the agent composite rating is above a predefined threshold, and
cause presentation of an indicator signifying a high agent composite rating in response to determining that the agent composite rating of the real estate agent is above the predefined threshold.

19. The system of claim 18, wherein the indicator is presented as part of a profile of the real estate agent hosted by the network-based real estate service.

20. A non-transitory machine-readable storage medium embodying instructions that, when executed by at least one processor of a machine, cause the machine to perform operations comprising:
accessing agent activity data representing one or more actions performed by a real estate agent while using a network-based real estate service;
calculating, using a processor of a machine, an engagement score for the real estate agent based on a first portion of the agent activity data, the engagement score indicating a level of engagement of the real estate agent with the network-based real estate service;
calculating a prospecting score for the real estate agent based on a second portion of the activity data, the prospecting score indicating a level of interaction of the real estate agent with consumers;
determining an agent composite rating for the real estate agent based in part on the engagement score and the prospecting score; and
causing presentation of the agent composite rating on a client device.
